(19) United States
(12) Patent Application Publication
(10) Pub. No.: US 2017/0130681 A1
(43) Pub. Date: May 11, 2017

(54) SNORKEL APPARATUS WITH ASSEMBLY CONNECTORS

(71) Applicant: Kyle Tallman, Waxahachie, TX (US)

(72) Inventor: Kyle Tallman, Waxahachie, TX (US)

(21) Appl. No.: 14/938,049

(22) Filed: Nov. 11, 2015

Related U.S. Application Data
(63) Continuation-in-part of application No. 29/545,079, filed on Nov. 9, 2015.

(51) Int. Cl. F02M 35/10; F02M 35/16; B60K 13/02

(52) U.S. Cl. CPC F02M 35/10013; B60K 13/02; F02M 35/161; B62K 5/01

(57) ABSTRACT

A snorkel for allowing an all-terrain vehicle (ATV”) to travel while at least partially submerged, in which the snorkel is constructed with connection elements that allow multiple snorkels to connect and form a single assembly.

### TECHNICAL FIELD OF THE INVENTION

The present disclosure relates generally to a snorkel kit for all-terrain vehicles (ATVs), allowing the engines to receive intake air though the engine itself may be underwater.

### RELATIONSHIP TO OTHER PATENT APPLICATIONS

The present disclosure invention is a continuation-in-part application of U.S. patent application Ser. No. 29/545,079, filed Nov. 9, 2015, and herein adopts the disclosure therein provided in full by reference.

### BACKGROUND OF THE INVENTION

Since at least the 1950s, specialty vehicles have been equipped with snorkels to allow them to travel while underwater, either in whole or in part. These snorkels are affixed to the intake manifold of combustion engines and extend to a height above the motor so it can operate while submerged.

As opposed to military vehicles which are produced in number to a specific design, casual ATV recreation users tend to be highly individualized, with vehicle owners installing after-market kits that require considerable modification to the vehicle on which the installation is occurring. Users prefer installations that require minimal changes to the vehicle to maintain resale value, while providing individualization.

Users also struggle with snorkel kits which are made of inexpensive polyvinyl chloride (PVC) pipes. PVC pipe do not appear to be an organic part of the vehicle. When damaged or even scratched, the white of the PVC piping is revealed, which is unsightly and therefore undesirable.

Even with a raised pipe from an engine's intake, water can splash up and into the intake of the pipes, causing the motor to sputter and even fail, necessitating a cover on the top of the pipes to keep out rain or casual splashing.

Many vehicles are designed with multiple air intake pipes, necessitating multiple snorkels which bring additional challenges. Taller snorkels should be carefully mounted to maintain stability as an ATV travels on violently uneven surfaces. If several snorkels are employed, they must be lashed together or affixed in some manner so their inertia does not eventually loosen them from their mounting.

To properly mount multiple snorkels, the industry needs to develop construction that allows a user to easily connect multiple snorkels into one assembly.

### SUMMARY OF THE INVENTION

The present disclosure provides a sliding male/female connection which allows individual snorkels to fit together and form a single assembly.

This sliding connection has a number of benefits, including its rugged construction that maintains a fixed spacing and orientation of the snorkels assembled together.

Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the disclosure, and to show by way of example how the same may be carried into effect, reference is now made to the detailed description along with the accompanying figures in which corresponding numerals in the different figures refer to corresponding parts and in which:

FIG. 1 depicts an orthogonal view of the back of the invention.

FIG. 2 depicts a bottom view of the riser depicts an orthogonal view of the invention's Riser.

FIG. 3 depicts a bottom (and top) view of the invention's Riser.

FIG. 4 depicts a front view of the invention's Riser.

FIG. 5 depicts a right side view of the invention's Riser.

FIG. 5A depicts the cross-section view defined by lines C-C on FIG. 5.

FIG. 6 is an orthogonal view of the invention's Bend.

FIG. 7 is a back view of the invention's Bend.

FIG. 8 is a bottom view of the invention's Bend.

FIG. 9 is a right side view of the invention's Bend.

FIG. 10 is a top view of the invention's Bend.

### DETAILED DESCRIPTION OF THE INVENTION

While the making and using of various embodiments of the present disclosure are discussed in detail below, it should be appreciated that the present disclosure provides many applicable inventive concepts, which can be embodied in a wide variety of specific contexts. The disclosure is primarily described and illustrated hereinafter in conjunction with various embodiments of the presently-described systems and methods. The specific embodiments discussed herein are, however, merely illustrative of specific ways to make and use the disclosure and do not limit the scope of the disclosure.

The inventor has constructed the invention using black molded 1.5″, 2″, and 3″ octagonal piping, but the drawings and discussion employ 2″ piping. Other diameters would work just as well and the invention is not limited to any particular size.

The invention as shown is constructed of two-piece molds, manufactured by special order for the inventor. Other construction types are possible, including one piece molding. The inventor is using two-piece molding for its cost, but construction types change with technology—the invention is not limited to the element construction as described.

This invention addresses the difficulty in properly mounting snorkels by adding a connection element that allows for an easy assembly of multiple snorkel tubes, and adds flat surfaces to the riser tubes which assist to make a stable connection between the invention and nearby mounting elements, such as roll bars and other vehicle frame structures.

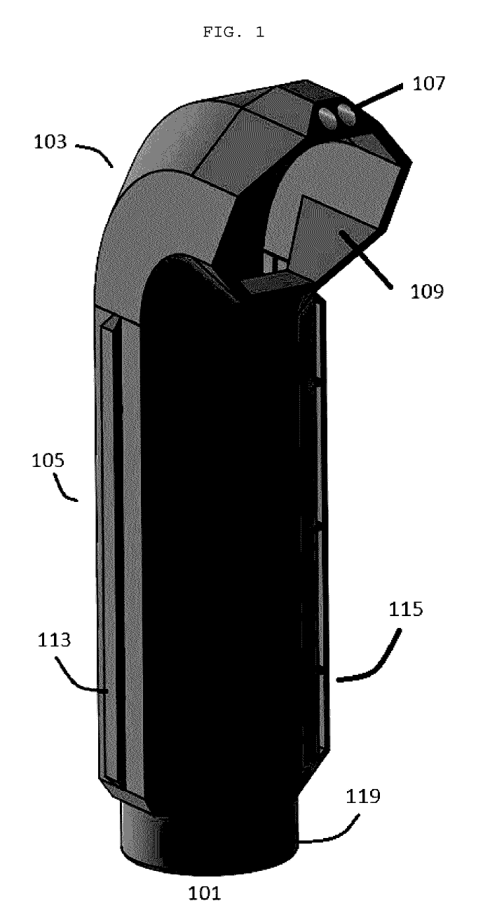

FIG. 1 depicts an orthogonal view of a single Snorkel Assembly 101, comprising a Bend 103 that sits on a Riser 105. On the top of the Bend 103, this view shows the Bend Aux Tube Guide 107, comprising two round holes molded into a raised portion of the Bend 103.

As this and all of the drawings show, the main body of the invention is roughly octagonal, a shape providing flat surfaces so the invention's front and back sides can sit flush with stability against a cross bar of an all-terrain vehicle. At the bottom of the snorkel is the round Hose Connection 119, making possible a traditional connection to the vehicle's intake using a hose clamp or other securing mechanism.

The Male Riser Connection 113 is visible to the left side of the Riser 105 in FIG. 1, and the Female Riser Connection is partially visible on the right side of the Riser 105. These connections allow a user to fix two of the Snorkel Assemblies 101 together and build a rugged snorkel grouped assembly that may be treated as one part for mounting purposes.

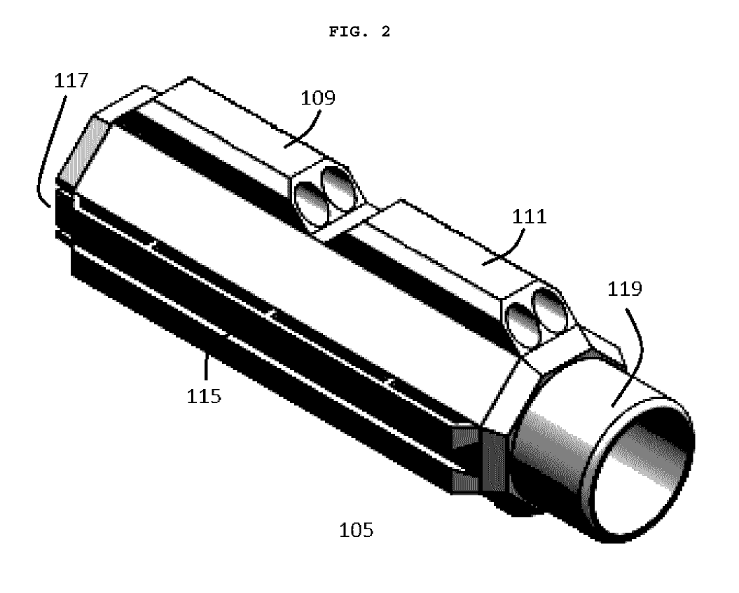

FIG. 2 shows just the Riser 105 element of the invention, comprising the hexagonal tube structure, rounded lower end, the Upper Aux Tube Guide 109 and Lower Aux Tube Guide 111, both of which have angled tube guide entrances, as well as the Female Riser Connection 115, Assembly Clip 117, and Hose Connection 119.

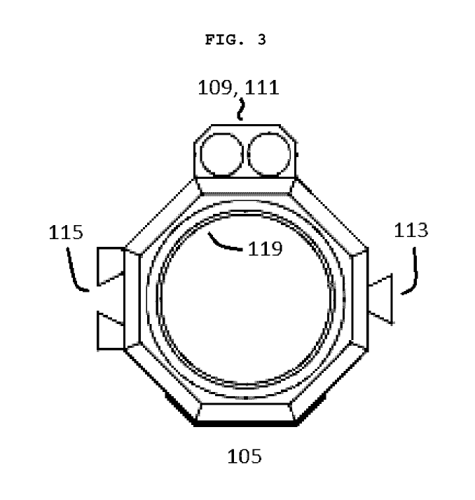

FIG. 3 shows the bottom view of the Riser 105, particularly the Male Riser Connection 113 and Female Riser Connection 115, and the outline of the Upper and Lower Aux Tube Guides 109, 111.

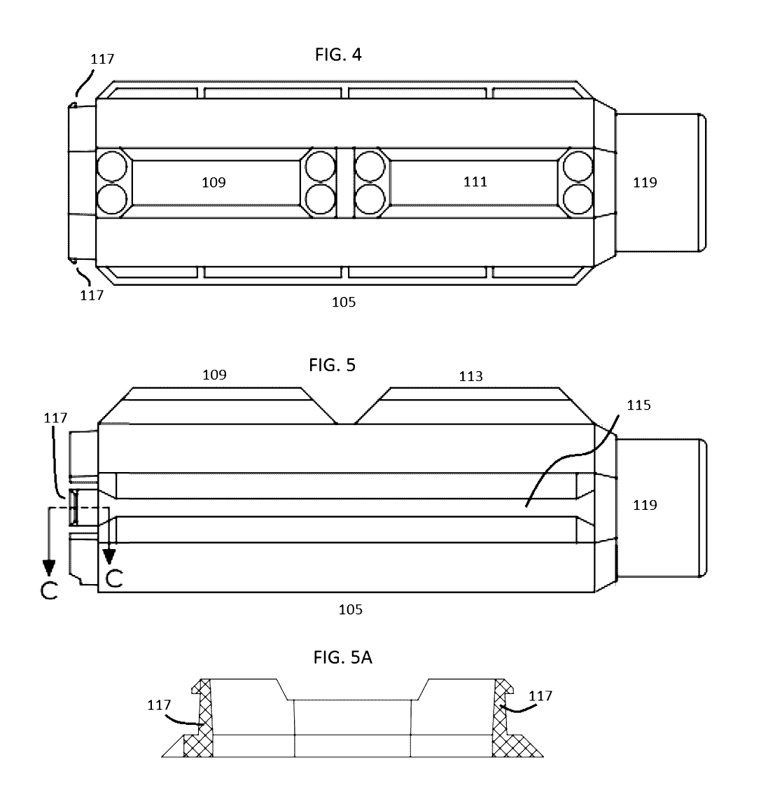

FIGS. 4 and 5 show a front and right side view of the Riser 105 and its constituent elements, including the Upper Aux Tube Guide 109, Upper Aux Tube Guide 109, Lower Aux Tube Guide 111, Hose Connection 119, and Assembly Clips 117.

FIG. 5A shows the cross-section of the Assembly Clip 117 which the current embodiment of the invention uses to affix the Bend 103 to the Riser 105.

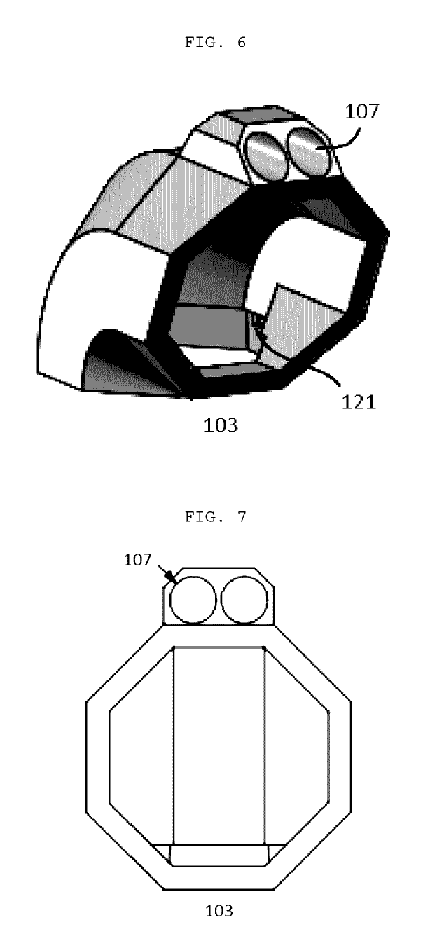

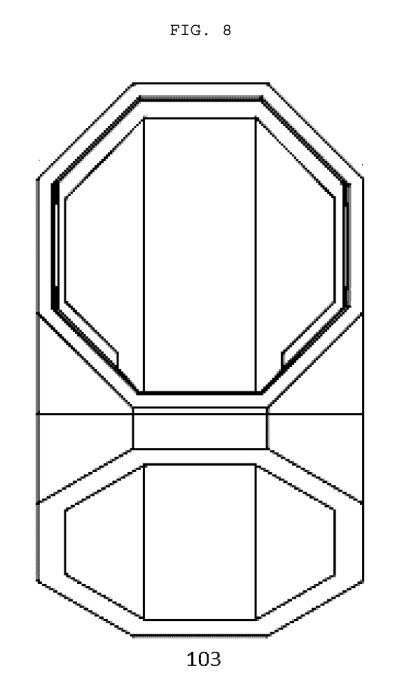

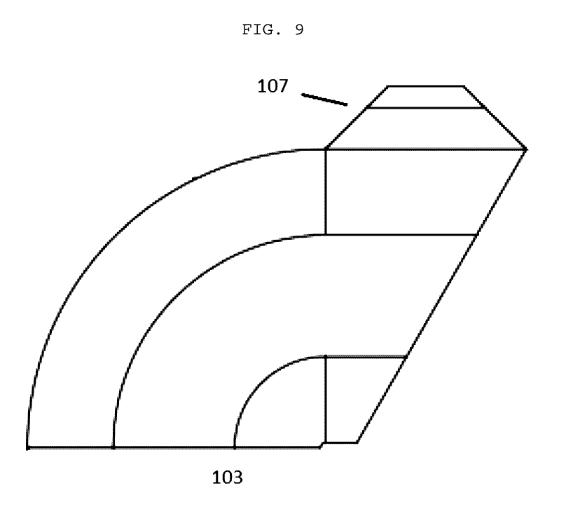

As shown in FIG. 6, the Bend 103 has an Assembly Ridge 121 built into both sides which match up to the Assembly Clip 117. To construct this embodiment of the invention, a user slides the Bend 103 onto the top of the Riser 105 which compresses the Assembly Clip 117 until it is far enough into the Riser 105 so that it then expands over the Assembly Ridge 121, holding the Snorkel Assembly 101 together.

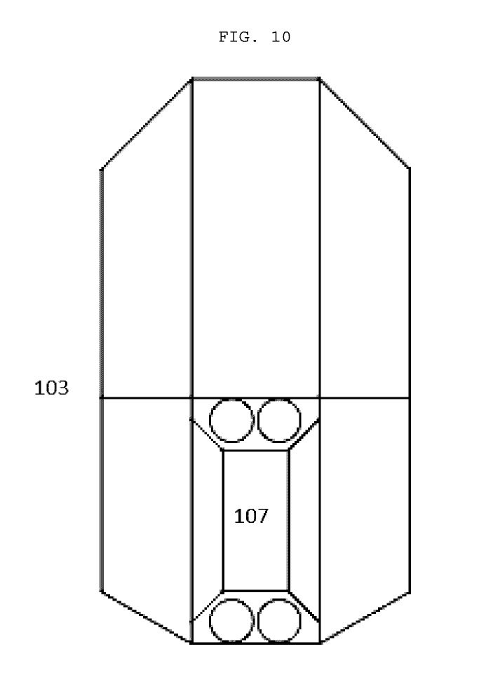

FIG. 9 shows one of the symmetrical sides of the invention's Bend 103. This view shows that the Bend Aux Tube Guide 107 is angled on each end for easy entrance and further shows the Bend 103 to be constructed so that any auxiliary tubes installed into the Guide 107 are protected in part from direct contact with debris which might impact the Bend 103 because the angled Guide 107 holds the auxiliary tube end in a recess which does not extend to the end of the Bend 103 (the rightmost point of the Bend as seen in FIG. 9).

FIG. 10 is a top view of the Bend 103 which also shows the Bend Aux Tube Guide 107 construction.

The octagonal shape of the Riser 105 allows for a sturdy flat surface so the invention can, when installed, sit flat against a roll bar or other nearby surface, rather than the usual round tube that more easily rolls on nearby surfaces.

Lastly, the Riser 105 has a Male Riser Connection 113 running vertically on one side, and a Female Riser Connection 115 running vertically on the opposite side. This construction allows a user to connect multiple Snorkel Assemblies 101 together so they create a rugged assembly that mounts as one device on a vehicle.

Not shown on the drawings or claimed at this point, a user could also use the Male and Female Riser Connections 113, 115 to connect the invention to appropriately-shaped clips mounted on a vehicle, so a user need only disconnect the bottom of the Snorkel Assembly 101 from a vehicle, and then slide the assembly off of the Riser Connections 113, 115. This mounting approach would be particularly appealing to an ATV user who often disassembles his vehicle and desires a way to remove or mount the invention quickly.

The embodiment described herein is presented for purposes of illustration and explanation only, as the invention can be constructed using many materials and configured in many ways in accordance with the present disclosure.

For example, the invention as shown in the drawings and discussed in this disclosure uses an octagonal-shaped Riser 105, but the invention would also function with a Riser 105 shaped in many ways, so long as it has a flat side for ease of mounting. The Male and Female Riser Connections 113, 115 could even be employed on a triangular-shaped Riser 105 by putting both a male and female connection on each of the three sides, so two triangular riser tubes can connect together, though this is a mere example and not considered the best embodiment by the inventor.

The invention as currently constructed uses a two-piece molded construction, but in the future, a single mold may be employed, or some other similar construction technique. In such an approach, the Assembly Clip 117 and Assembly Ridge 121 may not be necessary. In yet another alternative, the invention might be built in two halves, each shaped as a half-octagon, that snap together along the long sides.

A legend of the drawings includes the following:

101—Snorkel Assembly

103—Bend

105—Riser

107—Bend Aux Tube Guide

109—Upper Aux Tube Guide

111—Lower Aux Tube Guide

113—Male Riser Connection

115—Female Riser Connection

117—Assembly Clip

119—Hose Connection

121—Assembly Ridge

What is claimed is:

1) A snorkel assembly for an all-terrain vehicle (“ATV”), comprising:
a) a straight tube which is constructed to connect to an ATV air intake at one end;
b) a male connection element running along the length of the outside wall of the straight tube; and
c) a female connection element running along the opposite outside wall of the straight tube, located on the opposite side of the male connection and designed to interconnect with the male connection.

2) A snorkel assembly as in claim 1 in which the tube guide is shaped as a regular polygon with at least three defined flat is sides.

3) A snorkel assembly as in claim 1 in which the top of the snorkel assembly includes a bend in the tube that discourages rain from falling into the top of the tube.
